(19) United States
(12) Patent Application Publication
(10) Pub. No.: US 2026/0053136 A1
(43) Pub. Date: Feb. 26, 2026

(54) SANITIZING AND DISINFECTING COMPOSITIONS WITH DWELL TIME INDICATORS AND CLEANING ARTICLES CONTAINING THE SAME

(71) Applicant: KIMBERLY-CLARK WORLDWIDE, INC., Neenah, WI (US)

(72) Inventors: Xuedong SONG, Alpharetta, GA (US); Ning YANG, Suwanee, GA (US)

(21) Appl. No.: 18/998,633

(22) PCT Filed: Jul. 29, 2022
(86) PCT No.: PCT/US2022/038866

§ 371 Date: Jan. 27, 2025

(51) Int. Cl. A01N 33/12; A01N 25/02; A01N 25/22; A01N 33/04

(52) U.S. Cl. CPC A01N 33/12; A01N 25/02; A01N 25/22; A01N 33/04

(57) ABSTRACT

The invention relates to liquid sanitizing and/or disinfecting compositions comprising an active agent, an indicator compound, an acid, and a solvent. The compositions may be applied to a surface by spraying or transferring from cleaning article, in order to eliminate pathogens on the surface. The indicator compound may comprise a dye such as a cyanine dye, which provides a color to the composition and has at least one absorption maxima in the visible region. Once applied to the surface, the composition undergoes a color transition and becomes colorless.

### BACKGROUND

Sanitizing and disinfecting liquids are used to clean various surfaces in a variety of settings, including hospitals, medical offices, homes, commercial buildings, restaurants, and other publicly accessible facilities. Sanitizing and disinfecting liquid compositions typically include one or more active agents with antibacterial, antiviral, antifungal, and/or antiparasitic activity. These liquid compositions can be applied to a surface via a spray or can be transferred from a cleaning article (e.g., a substrate such as wipes, cloths, sponges, etc.) to the surface. However, as sanitizing and disinfecting liquids are often provided as clear and colorless solutions, a user cannot readily determine through visual inspection whether the entirety of a surface has been contacted with the sanitizing and/or disinfecting composition. Simply adding a conventional colorant to the liquid is not an acceptable solution as users will not tolerate permanent coloration of the cleaned surface.

Users are also unable to determine whether a sanitizing and/or disinfecting composition has contacted a surface in a sufficient concentration and for a sufficient duration to ensure the active agent has eliminated any target pathogen. Furthermore, cleaning articles can lose effectiveness over time if too much liquid is lost to evaporation. Without sufficient liquid, the composition may not transfer effectively from the substrate to the intended surface. Users often find it difficult to determine how much liquid has been lost from the article and, as a result, are often unable to determine whether a given cleaning article remains effective for eliminating target pathogens.

Accordingly, there is a need for sanitizing and disinfecting compositions that reliably indicate whether a surface has been contacted with a sanitizing and disinfecting liquid composition. There is also a need for sanitizing and disinfecting liquid compositions that reliably indicate the length of time the composition has been in contact with a surface. There is a further need for improved cleaning articles that reliably indicate whether sufficient liquid remains in the article to ensure proper transfer of the sanitizing and disinfecting composition to a surface.

In accordance with the purposes of the disclosed materials and methods, as embodied and broadly described herein, the disclosed subject matter, in one aspect, relates to compounds, compositions, and methods of making and using compounds and compositions.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments are set forth in the descriptions below. Other features, objects, and advantages will be apparent from the description and from the claims.

### SUMMARY OF THE DISCLOSURE

Disclosed herein are liquid compositions that include a dwell time indicator system. The compositions may be used to sanitize and/or disinfect a variety of different surfaces. The indicator system includes one or more cyanine dyes and one or more organic acids. The compositions are provided in a colored state (i.e., having some absorption in the visible spectrum) in a wet state and are transformed to a substantially colorless state upon application to a surface and vaporization of a significant portion of the composition. For example, in some implementations, the compositions are transformed to a substantially colorless state upon application to a surface and vaporization of 95% of the composition.

The liquid sanitizing and/or disinfecting compositions also include one or more active ingredients, for example, active ingredients that are antimicrobial, or antiviral, or anti-fungal, or possess a combination of these capabilities. The compositions further include a solvent or solvent mixtures. The compositions optionally include other chemicals, such as fragrances and viscosity modifiers.

Also disclosed herein are articles loaded with the liquid compositions. The compositions on the articles have one color when the liquid composition remains in a substantially wet state. The compositions on the articles become colorless when the solvents in the compositions have evaporated substantially.

### Definitions

Disclosed are components that can be used to perform the disclosed methods and systems. These and other components are disclosed herein. It should be understood that when combinations, subsets, interactions, groups, etc. of these components are disclosed, while specific reference of each various individual and collective combinations and permutation of these may not be explicitly disclosed, each is specifically contemplated and described herein for all methods and systems. This applies to all aspects of this application, including, but not limited to, steps in disclosed methods. Thus, if there are a variety of additional steps that can be performed it is understood that each of these additional steps can be performed with any specific embodiment or combination of embodiments of the disclosed methods.

As used in the specification and the appended claims, the singular forms “a,” “an” and “the” include plural referents unless the context clearly dictates otherwise. Ranges may be expressed herein as from “about” one particular value and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a straight-chain, branched, or cyclic hydrocarbon group having a specified range of carbon atoms (e.g., a “C₁₋₁₆ alkyl” can have from 1 to 16 carbon atoms). Unless specified to the contrary, an “alkyl” group includes both saturated alkyl groups and unsaturated alkyl groups. When an alkyl group is immediately preceded by the prefix ‘n’, the alkyl group is understood to be a linear, unbranched, alkyl group, e.g., n-butyl refers to the group *—CH₂CH₂CH₂CH₃. An “alkyl” group can be a cycloalkyl group, wherein all carbon atoms are part of a ring system or only a portion of the carbons in the alkyl group are part of a ring system. Unless specified to the contrary, an “alkyl” group includes both cyclic and acyclic alkyl groups.

Exemplary alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C) (e.g., n-hexyl). Additional examples of alkyl groups include n-heptyl (C₇), n-octyl (C₈), and the like. Unless otherwise specified, an alkyl group can be unsubstituted (an “unsubstituted alkyl”) or substituted (a “substituted alkyl”) with one or more substituents (e.g., F, Cl, Br, I, OH, COOH, phenyl, and the like).

The term “aryl” refers to a radical of a monocyclic or polycyclic (e.g., bicyclic or tricyclic) 4n+2 aromatic ring system (e.g., having 6, 10, or 14 n electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, includes non-aromatic carbon atoms, e.g., alkyl groups, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group can be phenyl, 1-naphthyl, 2-naphthyl, 4-methylphenyl, 2-methylphenyl, or 4-chlorophenyl)

“Aralkyl” or “alkaryl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring and, in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system.

A group is optionally substituted unless expressly provided otherwise. The term “optionally substituted” refers to being substituted or unsubstituted. “Optionally substituted” refers to a group which may be substituted or unsubstituted (e.g., “substituted” or “unsubstituted” alkyl or “substituted” or “unsubstituted” aryl). In general, the term “substituted” means that at least one hydrogen present on a group is replaced with a permissible substituent (e.g., a substituent which upon substitution results in a stable compound, e.g., a compound which does not spontaneously undergo transformation such as by rearrangement, cyclization, elimination, or other reaction). Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds and includes any of the substituents described herein that results in the formation of a stable compound.

Exemplary substituents include, but are not limited to, —SO₃H, PO₃H₂, —OH, —OR^{aa}, —N(R^{aa})₂, —N(R^{aa})₃⁺X⁻, and —CO₂H, wherein X⁻ is a counterion, wherein each instance of R^{aa} is independently selected from H and C₁₋₁₀ alkyl, and wherein two or more R^{aa} groups can together form a 3-14 membered heterocyclyl or 5-14 membered heteroaryl ring,

The term “hydroxyl” or “hydroxy” refers to the group —OH.

When a compound is present in an ionized form, having one or more positively charged or negatively charged atoms, it is understood to be accompanied by a sufficient number of counterions to ensure overall charge neutrality. Ionizable compounds (i.e., compounds capable of accepting or donating a proton) may be provided in the form of acceptable salts. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate. Suitable counterions include the conjugate acids and bases of the aforementioned inorganic acids, organic acids, metal hydroxides, metal carbonates, and metal sulfates.

To assess the performance and characteristics of the disclosed embodiments, certain analyses may be conducted under “standard conditions.” As used herein, “standard conditions” refers to 23° C. and 1 atm of pressure. Unless specified to the contrary, a “flat surface” refers to any impermeable substrate onto which a liquid may be deposited, wherein, after a specified amount of liquid is deposited (e.g., 1 ml), the liquid may spread freely without encountering an edge, side wall, or other topological deviation from the flat surface.

Cyanine dyes are compounds having two trisubstituted nitrogen atoms conjugated to one another via a (poly)methine chain, wherein one of the two nitrogen atoms is in the oxidized (iminium) form. A cyanine dye has the general structure:

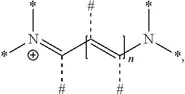

wherein n is 0-6, each * is independently any alkyl, aryl, or heteroaryl group, and each # is independently H, F, Cl, Br, I, COOH, alkoxy, alkyl, aryl, or heteroaryl group, wherein any two or more * and # groups may together form a ring. The counter-anion is present, but not depicted, and may be provided as a separate ionic species (e.g., F⁻, Cl⁻, Br⁻, I⁻, acetate, sulfate, nitrate, phosphate, etc), or provided by a substituent on a * or # group (e.g., carboxylate, sulfonate, phosphonate, etc.). A poly(methine) chain will typically adopt the most thermodynamically stable configuration (for example, all-trans), however, unless specified to the contrary, the depiction of an olefin in one geometric configuration does not exclude any other possible geometric configuration.

A trisubstituted nitrogen atom in a cyanine may be acyclic, e.g., neither of the * groups attached to nitrogen atom form a ring system with each other or an adjacent # group. In other embodiments, the nitrogen atom may be part of a ring system, for example:

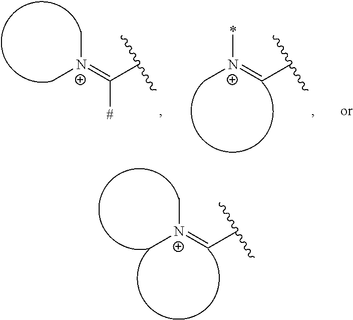

Cyanine dyes in which both nitrogen atoms are part of ring systems are designated closed cyanines, compounds in which one nitrogen is part of a ring system are designated hemicyanines, and compounds in which neither nitrogen atom is part of a ring system are designated streptocyanines. Compounds in which ‘n’ is 0 are designated apocyanines.

Merocyanine dyes are compounds having a trisubstituted nitrogen atom conjugated to a carbonyl or similar electron accepting group:

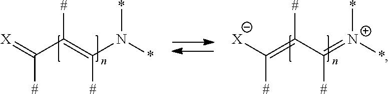

wherein X is O, S, or N (either imine or cyano).

“Eliminating” as used herein in the context of sanitizers or disinfectants refers to killing, eradicating, preventing the multiplication of, or otherwise inactivating a pathogen.

“Sanitizing” as used herein refers to the process of eliminating bacteria, optionally accompanied by the elimination of one or more other pathogens.

“Disinfecting” as used herein refers to the process of eliminating bacteria and viruses, optionally accompanied by the elimination of one or more other pathogens.

### DETAILED DESCRIPTION

Disclosed herein are liquid compositions. The compositions can be used to sanitize and/or disinfect surfaces. The compositions can include a solvent, an active agent, an acid, and an indicator compound. The compositions may be applied to a surface (e.g., by spray or transfer from a cleaning article) to eliminate pathogens on the surface. The indicator compound provides a visible color to the composition in a wet state, the compound having at least one absorption maxima in the visible region. Once applied to a surface, the composition undergoes a discoloration transition (e.g., transitioning from colored to colorless) when the composition becomes substantially dry.

### Compositions

The compositions disclosed herein may include one or more solvents. In certain implementations, the solvent is an organic solvent. In some implementations, the solvent is a volatile organic solvent. In some embodiments, the organic solvent has a boiling point (at 1 atm) of less than 150° C., less than 140° C., less than 130° C., less than 120° C., less than 110° C., less than 100° C., less than 90° C., less than 80° C., less than 70° C., less than 60° C., or less than 50° C. In other embodiments, the organic solvent has a boiling point (at 1 atm) from 50-150° C., from 50-75° C., from 75-100° C., from 100-125° C., from 125-150° C., from 50-100° C., from 75-125° C., or from 100-150° C. In some preferred implementations, the solvent is an organic solvent having a boiling point of 120° C. or less.

In some embodiments, the organic solvent includes an alcohol, for example a C₁₋₈ alkylalcohol, C₁₋₆alkylalcohol, C₁₋₄alkylalcohol, or C₁₋₂alkylalcohol. In certain embodiments, the organic solvent is an alkylalcohol having a single hydroxyl group, while in other embodiments the organic solvent is an alkylalcohol having two hydroxyl groups. Exemplary alkylalcohols include methanol ethanol, propanol, isopropanol, butanol, sec-butanol, tert-butyl alcohol, isobutanol, pentanol, isoamyl alcohol, 2-methyl-1-butanol, neopentyl alcohol, 2-pentanol, 3-methyl-2-butanol, 3-pentanol, tert-amyl alcohol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 3,3-dimethyl-1-butano, pentanols, hexanols, octanols, and the like.

In some embodiments, the organic solvent includes a ketone or ester, for example C₁₋₈ ketone, C₁₋₆ketone, C₁₋₄ketone, C₁₋₂ketone, C₁₋₈ester, C₁₋₆ester, C₁₋₄ester, or C₁₋₂ester. Exemplary ketones include acetone, methylethylketone (2-butanone), and the like. Exemplary esters include ethyl acetate, methyl acetate, isopropyl acetate, butyl acetate, and the like. In further embodiments, the organic solvent can include a mixed ester/ketone, for example 1-acetoxyacetone.

In some embodiments, the composition includes water, either as the sole solvent or in combination with one or more organic solvents as defined above. In other embodiments, the composition will not include water. As used herein, a composition that does not include water is not meant to exclude compositions having incidental water (e.g., residual water present in commercially available solvents).

In some embodiments, the composition contains water in an amount from 0-5%, from 0-2.5%, from 0-1.5%, from 0-1%, from 0-0.5%, from 0-0.25%, or from 0-0.1%, on a v/v basis. In other embodiments, the water can be present in an amount from 5-95%, from 5-50%, from 5-25%, from 5-15%, from 5-10%, from 10-20%, from 15-30%, from 25-50%, from 40-60%, from 25-75%, from 50-75%, from 50-95%, from 75-95%, from 80-95%, or from 90-95%, on a v/v basis.

The compositions disclosed herein can include one or more active agents with sanitizing and/or disinfecting capability. For example, the composition can include one or more antibacterial, antiviral, antifungal, and/or antiparasitic agents. The skilled person understands that many compounds exhibit a spectrum of activity against different types of organisms. As such, unless specified explicitly to the contrary, the designation of the active agent as a bactericidal agent does not exclude compounds that have additional activity as well, e.g., both bactericidal and fungicidal activity.

In some instances, the composition can include the active agent(s) in an amount from 0.01-25 wt. % (relative to the total weight of the composition). For example, the composition can include the active agent in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %.

In certain embodiments, the active agent can include a quaternary ammonium compound (“quat”). The quat can be a compound having the formula:

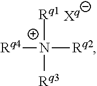

wherein R^{q1}, R^{q2}, R^{q3}, and R^{q4} are independently selected from C₁₋₂₀alkyl, C₀₋₄alkaryl, and C₀₋₄alkheteroaryl, wherein any two or more of R^{q1}, R^{q2}, R^{q3}, and R^{q4} can together form a saturated or unsaturated ring, and X^{q} is an acceptable anion. Preferred C₀₋₄alkaryl groups include phenyl, benzyl, and 2-phenylethyl. Each R^{q1}, R^{q2}, R^{q3}, and R^{q4} may be optionally substituted one or more times with groups like aryl, hydroxyl, carboxylate, or oxo. In some embodiments R^{q3} and R^{q4} can together form a piperidine ring. In some embodiments, R^{q2}, R^{q3}, and R^{q4} can together form a pyridinium, imidazolinium, pyrrolidinium, or [2.2.2] bicyclooctyl ring.

Preferred X^{q} groups include chloride, bromide, iodide, sulfate, propionate, methosulfates, saccharinate, ethosulfate, hydroxide, acetate, phosphate, carbonate, bicarbonate, salicylate, and nitrate.

In certain embodiments, R^{q2}, R^{q3}, and R^{q4} are each independently selected from C₁₋₄alkyl, preferably methyl or ethyl, and R^{q1} is C₆₋₂₀alkyl or C₀₋₄alkaryl, preferably benzyl, phenyl, or 2-phenylethyl. In some embodiments, R^{q3} and R^{q4} are each methyl, R^{q2} is C₄₋₁₀alkyl, and R^{q1} is C₇₋₂₀alkyl or C₀₋₄alkaryl.

Exemplary quat compounds include alkyl dimethyl benzyl ammonium chloride, alkyl dimethyl ethylbenzyl ammonium chloride, octyl decyl dimethyl ammonium chloride, dioctyl dimethyl ammonium chloride, didecyl dimethyl ammonium chloride, benzethonium chloride, ethylbenzyl alkonium chloride, ethyl benzethonium chloride, myristyl trimethyl ammonium chloride, methyl benzethonium chloride, cetalkonium chloride, cetrimonium bromide (CTAB), carnitine, dequalinium chloride, dofanium chloride, tetraethyl ammonium bromide (TEAB), domiphen bromide, octenidine dihydrochloride, cetrimide, benzododecinium bromide, benzoxonium chloride, choline, and denatonium.

The composition can include the quat(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include a quat.

The composition can include one or more biguanide compounds, which includes polyhexanides. In some embodiments, the biguanide can have the formula:

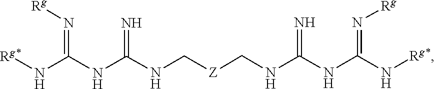

wherein one of R^{g} and R^{g*} is H, and the other is H, aryl, alkyl, or heteroaryl, Z is (CH₂)_{z}, and z is 0-12, 2-12, 2-10, 2-8, 4-8, or 4-6p, and preferably 4, 5, or 6. In some embodiments, one of R^{g} and R^{g*} is H, and the other is aryl, alkyl, or heteroaryl. The skilled person understands that such biguanides may also exist as tautomers (e.g., tautomer 1: R^{g} is H, and R^{g*} is aryl, alkyl, or heteroaryl; and tautomer 2: R^{g*} is H, and R^{g} is aryl, alkyl, or heteroaryl). These tautomers can interconvert depending on thermodynamics and chemical environment, and, unless specified to the contrary, the designation of one tautomeric form is inclusive of the other. In certain preferred embodiments, one of R^{g} and R^{g*} is aryl (e.g., phenyl, 2-chlorophenyl, 4-chlorophenyl, 4-methylphenyl, 4-trifluoromethoxyphenyl, especially 4-chlorophenyl). In other embodiments, one of R^{g} and R^{g*} is C₁₋₁₈alkyl, preferably C₃₋₁₂alkyl, C₄₋₁₀alkyl, C₄₋₈alkyl, or C₆₋₈alkyl, and even more preferably unsubstituted C₃₋₁₂alkyl, unsubstituted C₄₋₁₀alkyl, unsubstituted C₄₋₈alkyl, or unsubstituted C₆₋₈alkyl.

The composition can include the biguanide(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include a biguanide.

Exemplary biguanides include ethylenedibiguanide, propylenedibiguanide, tetramethylenedibiguanide, pentamethylenedibiguanide, hexamethylenedibiguanide, heptamethylenedibiguanide, octamethylenedibiguanide, 1,6-bis-(4-chlorobenzylbiguanido)-hexane (Fluorhexidine®), 1,1′-hexamethylene bis(5-(p-chlorophenyl)biguanide) (chlorhexidine), 2-(benzyloxymethyl)pentane-1,5-bis(5-hexylbiguanide), 2-(phenylthiomethyl)pentane-1,5-bis(5-phenethylbiguanide), 3-(phenylthio)hexane-1,6-bis(5-hexylbiguanide), 3-(phenylthio)hexane-1,6-bis(5-cyclohexylbiguanide), 3-(benzylthio)hexane-1,6-bis(5-hexylbiguanide), and 3-(benzylthio)hexane-1,6-bis(5-cyclohexylbiguanide), phenylenyldibiguanide, naphthylenyldibiguanide, pyridinyldibiguanide, piperazinyldibiguanide, phthalyldibiguanide, 1,1′-[4-(dodecyloxy)-m-phenylene]bisbiguanide, 2-(decylthiomethyl)pentane-1,5-bis(5-isopropylbiguanide), 2-(decylthiomethyl)pentane-1,5-bis(5,5-diethylbiguanide), alexidine, salts thereof, and combinations thereof.

In some embodiments, the composition can include one or more surfactants. Exemplary surfactants include non-ionic surfactants and ionic surfactants, for instance cationic surfactants, anionic surfactants, and zwitterionic surfactants. The composition can include the surfactant(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include a surfactant.

In certain embodiments, the composition includes one or more anionic surfactants, for example a sulfonate surfactant, a carboxylate surfactant, or a sulfate surfactant. Exemplary anionic surfactants include sodium alkyl sulfate and sulfonates. Suitable carboxylate surfactants include metal salts (including alkali and alkaline earth metals) of fatty acids, such as C₈₋₂₄ fatty acids. In some instances, the anionic surfactant is sodium dodecyl sulfate, sodium dodecylbenzenesulfonate, sodium laurate, sodium laureth sulfate, sodium lauryl sarcosinate, potassium lauryl sulfate, ammonium lauryl sulfate, ammonium laureth sulfate, ammonium xylene sulfonate, magnesium laureth sulfate, sodium myreth sulfate, sodium nonanoyloxybenzenesulfonate, or ammonium xylene sulfonate.

The composition can include the anionic surfactant(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include an anionic surfactant.

In some embodiments, the composition includes one or more non-ionic surfactants. In some embodiments the non-ionic surfactant is C₇₋₂₄fatty acid esters, C₁₀₋₂₄fatty alcohol ethers, C₈₋₂₄ amine oxides, nonylphenol ethoxylate, alkyl polyglucosides (for instance having C₅₋₁₈alkyl chains). Exemplary non-ionic surfactants include cetyl alcohol, stearyl alcohol, cetostearyl alcohol, and oleyl alcohol, poloxamers (block copolymers of polyethylene glycol and polypropylene glycol), ethoxylated fatty alcohols such as PEG-80 sorbitan laurate, polyoxyethylene glycol alkyl ethers like pentaethylene glycol monododecyl ether, octaethylene glycol monododecyl ether, polyoxypropylene glycol alkyl ethers, glucoside alkyl ethers, polyoxyethylene glycol octylphenol ethers, polyoxyethylene glycol alkylphenol ethers such as nonoxynol-9, glycerol alkyl esters such as glyceryl laurate, polyoxyethylene glycol sorbitan alkyl esters like polysorbate, sorbitan alkyl esters, cocamide MEA, cocamide DEA, amine oxides, such as dodecyldimethylamine oxide, polyethoxylated tallow amine, and mixtures thereof.

The composition can include the non-ionic surfactant(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include a non-ionic surfactant.

In some embodiments, the composition includes one or more zwitterionic surfactants. Exemplary zwitterionic surfactants include betaines such as cocamidopropyl betaine, sultaines such as cocamidopropyl hydroxyl sultaine and lauramidopropyl hydroxyl sultaine, amphoacetates and amphodiacetates, such as disodium lauroamphodiacetate, disodium cocoamphodiacetate, sodium lauroamphoacetate, sodium cocoamphoacetate, disodium cocoamphodipropionate and disodium lauroamphodipropionate. In some embodiments, the composition can include one or more zwitterionic surfactants selected from 4-[N,N-di(2-hydroxyethyl)-N-octadecylammonio]-butane-1-carboxylate, S—[S-3-hydroxypropyl-S-hexadecylsulfonio]-3-hydroxypentane-1-sulfate, 3-[P,P-diethyl-P-3,6,9-trioxatetradexopcylphosphonio]-2-hydroxypropane-1-phosphate, 3-[N,N-dipropyl-N-3-dodecoxy-2-hydroxypropylammonio]-propane-1-phosphonate, 3-(N,N-dimethyl-N-hexadecylammonio)propane-1-sulfonate, 3-(N,N-dimethyl-N-hexadecylammonio)-2-hydroxypropane-1-sulfonate, 4-[N,N-di(2-hydroxyethyl)-N-(2-hydroxydodecyl)ammonio]-butane-1-carboxylate, 3-[S-ethyl-S-(3-dodecoxy-2-hydroxypropyl)sulfonio]-propane-1-phosphate, 3-[P,P-dimethyl-P-dodecylphosphonio]-propane-1-phosphonate, 5-[N,N-di(3-hydroxypropyl)-N-hexadecylammonio]-2-hydroxy-pentane-1-sulfate, lauryl hydroxysultaine, and combinations thereof.

The composition can include the zwitterionic surfactant(s) in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %. In other embodiments, the composition does not include a zwitterionic surfactant.

The disclosed compositions can include one or more acids such as C₁₋₁₂alkyl groups, aryl ring, and heteroaryl rings substituted with one or more carboxylic acids. In some embodiments, the composition includes one or more compounds having a single acidic group (e.g., a single carboxylic acid). Such compounds may be designated as monoacids. Exemplary monoacids include gluconic acid and picolinic acid. In other embodiments, the composition includes a compound having two or more acidic groups. Such compounds may be designated as polyacids. Exemplary compounds having two acidic groups include phthalic acid, fumaric acid, tartaric acid, malic acid, maleic acid, and glutaric acid. In further embodiments, the acid is a compound having three acidic groups. Exemplary compounds with three acidic groups compounds include citric acid and tremesic acid. The composition may include an acid having more than three acidic groups, for example phytic acid and mellitic acid.

The composition can include an acid having a pKa from 0-6.5, from 1-6.5, from 2-6.5, from 3-6.5, from 4-6.5, from 5-6.5, from 1-3, from 2-4, or from 3-5 (measured in water at 23° C.). In cases of compounds having more than one acidic group, pKa relates to the dissociation of the most acidic proton.

In some embodiments, the composition can include one or more non-volatile acids. As used herein, a non-volatile acid is a compound that does not substantially vaporize under standard conditions. In some embodiments, the non-volatile acid can have a boiling point (at 1 atm) of at least 100° C., at least 125° C., at least 150° C., at least 200° C., at least 250° C., at least 300° C., at least 350° C., or at least 400° C. In some embodiments, the non-volatile acid can have a melting point of at least 75° C., at least 100° C., at least 125° C., at least 150° C., at least 175° C., at least 200° C., at least 250° C., or at least 300° C.

In certain embodiments the composition can include one or more acids selected from adipic acid, ascorbic acid, benzene dicarboxylic acid, benzoic acid, butyric acid, citric acid, cresylic acid, capric acid, caproic acid, cyanuric acid, dihydroacetic acid, 2-ethyl-hexanoic acid, formic acid, fumaric acid, gluconic acid, glycolic acid, 1-glutamic acid, isopropyl sulfamic acid, lactic acid, maleic acid, malic acid, mesyl acid, naphthenic acid, oxalic acid, phytic acid, propanoic acid, salicylic acid, sorbic acid, tartaric acid, valeric acid, and combinations thereof.

In preferred embodiments, the acid is selected from tartaric acid, fumaric acid, citric acid, and malic acid.

The acid(s) can be present in the composition in a concentration from 0.05-50 mg/ml, from 10-50 mg/ml, from 25-50 mg/ml, from 10-25 mg/ml, from 0.05-25 mg/ml, from 0.05-10 mg/ml, from 0.1-10 mg/ml, from 0.5-10 mg/ml, from 1-10 mg/ml, from 2-10 mg/ml, from 4-10 mg/ml, from 5-10 mg/ml, from 7.5-10 mg/ml, from 0.05-2.5 mg/ml, from 0.1-2.5 mg/ml, from 0.5-2.5 mg/ml, from 1-2.5 mg/ml, from 1-5 mg/ml, or from 2.5-5 mg/ml.

The disclosed compositions include one or more indicators. The indicator can be a dye, for example a polymethine dye. In certain embodiments the indicator is a cyanine dye. In some embodiments, the indicator is a streptocyanine, hemicyanine, closed chain cyanine, merocyanine, apocyanine, or combination thereof.

In certain embodiments, the indicator is quinocyanine, isoquinocyanine, or mixed quino/isoquinocyanine. Quinocyanines are closed chain cyanines in which each nitrogen atom forms part of a quinoline ring. Isoquinocyanines are closed chain cyanines in which each nitrogen atom forms part of an isoquinoline ring. Mixed quino/isoquinocyanine are closed chain cyanines in which one nitrogen atom forms part of a quinoline ring, and the other nitrogen atom forms part of an isoquinoline ring. Exemplary quinocyanines, isoquinocyanines, and mixed quino/isoquinocyanine include compounds such as:

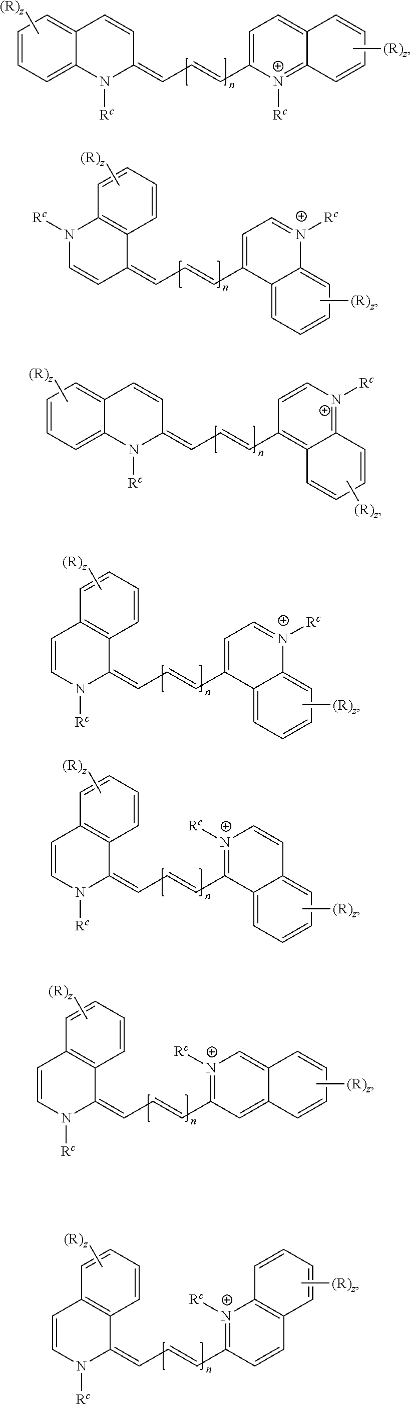

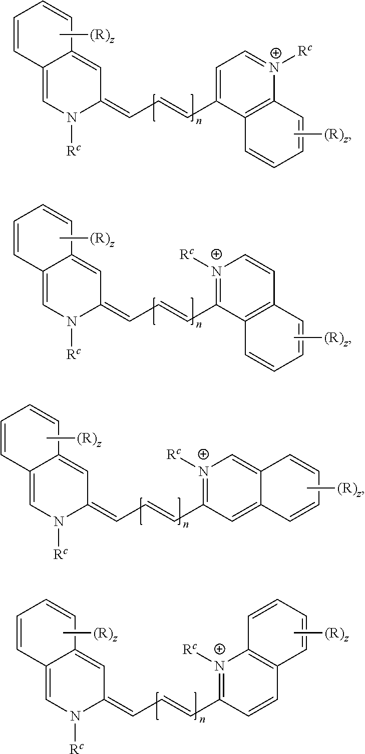

(counter-anion not depicted), wherein n is 0-6, R^{c} is optionally substituted C₁₋₈alkyl, X is an acceptable anion, z is 0-6, and R is independently selected from F, Cl, Br, I, OH, COOH, CN, C₁₋₈alkyl, aryl, C₁₋₈alkoxy, NH₂, NHC₁₋₈alkyl, and N(C₁₋₈alkyl)₂. Preferably z is 0 or 1, most preferably 0. Acceptable counter-anions include chloride, bromide, or iodide. Preferably n is 1-3, even more preferably 1-2, and especially 1.

In other embodiments, the indicator can a compound having the formula:

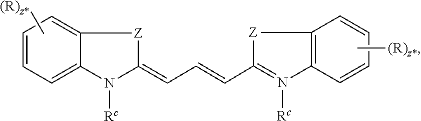

wherein n, X, R, and R^{c} is as defined above, z* is 0-4, and Z is C(CH₃)₂, O, S, or NCH₃. Preferably z* is 0 or 1, most preferably 0.

In some embodiments, R^{c} may be substituted one or more times by a solubility-modifying group, for example phenyl, N(CH₃)₂, OH, COOH, [(CH₃)₃N⁺], SO₃H, or PO₃H₂ (and salts thereof). For embodiments in which R^{c} is substituted with an ionizable group capable of bearing a negative charge (e.g., COOH, SO₃H, or PO₃H₂), a separate counterion need not be present so long as the compound is electrochemically balanced.

In some embodiments, the indicator is a compound where Z=C(CH₃)₂, n=1, 2, or 3, and R^{c} is ethyl, methyl, butyl, or 4-sulfonatobutyl.

The acid and indicator may be combined in a variety of ratios. For example, the composition may include the acid and indicator in a weight ratio from 1:1 to 500:1, from 1:1 to 250:1, from 1:1 to 100:1, from 1:1 to 75:1, from 1:1 to 50:1, from 1:1 to 40:1 from 1:1 to 30:1, from 1:1 to 20:1, from 1:1 to 10:1, from 5:1 to 50:1, from 10:1 to 25:1, from 10:1 to 50:1, from 20:1 to 50:1, from 25:1 to 50:1, from 25:1 to 75:1, from 50:1 to 100:1, from 50:1 to 150:1, or from 100:1 to 500:1. For embodiments in which multiple indicators and/or acids are present, the weight ratios disclosed here refer to the total amount of each component.

In certain embodiments, the composition can include one or more compounds selected from propionic acid and salts thereof; salicylic acid and salts thereof; sorbic acid and salts thereof; benzoic acid and salts and esters thereof; formaldehyde; paraformaldehyde; o-phenylphenol and salts thereof; zinc pyrithione; inorganic sulfites; hydrogen sulfites; chlorobutanol; benzoic parabens, such as methylparaben, propylparaben, butylparaben, ethylparaben, isopropylparaben, isobutylparaben, benzylparaben, sodium methylparaben and sodium propylparaben; dehydroacetic acid and salts thereof; formic acid and salts thereof; dibromohexamidine isethionate; thimerosal; phenylmercuric salts; undecylenic acid and salts thereof; hexetidine; 5-bromo-5-nitro-1,3-dioxane; 2-bromo-2-nitropropane-1,3,-diol; dichlorobenzyl alcohol; triclocarban; p-chloro-m-cresol; triclosan; chloroxylenol; imidazolidinyl urea; polyaminopropyl biguanide; phenoxyethanol, methenamine; quaternium-15; climbazole; DMDM hydantoin; benzyl alcohol; piroctone olamine; bromochlorophene; o-cymen-5-ol; methylchloroisothiazolinone; methylisothiazolinone; chlorophene; chloroacetamide; chlorhexidine; chlorhexidine diacetate; chlorhexidine digluconate; chlorhexidine dihydrochloride; phenoxyisopropanol; alkyl (C₁₂₋₂₂) trimethyl ammonium bromide and chlorides; dimethyl oxazolidine; diazolidinyl urea; hexamidine; hexamidine diisethionate; glutaral; 7-ethylbicyclooxazolidine; chlorphenesin; sodium hydroxymethylglycinate; silver chloride; benzethonium chloride; benzalkonium chloride; benzalkonium bromide; benzylhemiformal; iodopropynyl butylcarbamate; ethyl lauroyl arginate HCI; citric acid; and silver citrate.

The compositions may be formulated at different acidic pH levels. In certain embodiments, the composition has a pH from 1-6, from 2-5, from 2-4, from 3-8, or from 4-5.

The disclosed compositions can include an antioxidant, for example butylated hydroxytoluene, ascorbic acid, ascorbic palmitate, butylated hydroxyanisole, 2,4,5-trihydroxybutyrophenone, 4-hydroxymethyl-2,6-di-tert-butyl phenol, erythorbic acid, gum guaiac, propyl gallate, thiodipropionic acid, dilauryl thiodipropionate, tert-butylhydroquinone, tocopherol, sodium metabisulfite, sodium sulfite, or a combination thereof. The antioxidant may be present in the compositions in an amount from 0.01-1.0 wt %, from 0.01-0.75 wt %, from 0.01-0.5 wt %, from 0.01-0.25 wt %, from 0.01-0.1 wt %, from 0.05-0.15 wt %, from 0.1-1.0 wt %, from 0.1-0.5 wt %, from 0.1-0.25 wt %, from 0.25-1.0 wt %, from 0.5-1.0 wt %, or from 0.25-0.75 wt %. In other embodiments, the composition does not include an antioxidant.

The compositions may be formulated at a viscosity suitable for applying to surfaces. Viscosity may be measured at 23° C., at a shear rate of 1 Hz. Suitable viscosities for the compositions include 1-500 cps, 250-500 cps, 100-500 cps, 100-250 cps, 100-200 cps, 1-250 cps, 1-100 cps, 1-75 cps, 1-50 cps, 1-25 cps, 1-20 cps, 1-15 cps, 1-10 cps, 5-25 cps, 5-50 cps, 10-50 cps, or 10-100 cps.

The compositions may include one or more viscosity modifiers to provide the aforementioned rheological properties. Suitable viscosity modifiers include celluloses (including cellulose derivatives, such as methyl cellulose, ethyl cellulose, hydroxypropyl methylcellulose, carboxymethylcellulose, and the like), gums, poly(meth)acrylates, starches, polyethylene glycols, and the like. In some embodiments, the composition includes one or more PEG-stearates, PEG-di-stearates, or PEG-iso-stearates. In some embodiments, the composition includes one or more xanthan gum, guar gum, potato starch, or corn starch. In some embodiments, the composition includes polyacrylamidomethylpropane sulfonic acid, polyvinylpyrrolidone (PVP), or butylated PVP. In some embodiments, the composition does not include a viscosity modifier. The viscosity modifier may be present in the compositions in an amount from 0.01-10.0 wt %, from 0.01-5.0 wt %, from 0.01-2.5.0 wt %, from 0.01-1.0 wt %, from 0.01-0.5 wt %, from 0.1-1.0 wt %, from 0.1-2.5 wt %, from 1.0-2.5 wt %, from 1.0-5.0 wt %, from 2.5-5.0 wt %, from 2.5-7.5 wt %, from 5.0-10.0 wt %, or from 7.5-10 wt %.

In some embodiments, the composition may include one or more fragrances. The fragrance may be present in an amount no more than 5 wt. %, no more than 4 wt. %, no more than 3 wt. %, no more than 2 wt. %, no more than 1 wt. %, no more than 0.75 wt. %, no more than 0.5 wt. %, no more than 0.25 wt. %, no more than 0.1 wt. %, or no more than 0.05 wt. %. In other embodiments, the composition does not include a fragrance.

The disclosed compositions are provided in a colored state, absorbing light in the visible region. In some embodiments, the compositions have an absorption maxima between 400-750 nm, between 400-700 nm, between 400-600 nm, between 400-500 nm, between 400-600 nm, between 450-550 nm, between 450-550 nm, between 500-600 nm, between 500-700 nm, between 550-650 nm, between 600-700 nm, or between 650-750 nm. In certain embodiments, the compositions have a single absorption maxima in the region between 400-750 nm. Upon exposure to standard conditions, the compositions can undergo a discoloration. For example, after exposure to standard conditions for a period of 180 seconds, the absorption maxima can be reduced by an amount of at least 80%, at least 85%, at least 90%, at least 95%, at least 97.5%, or at least 99%. The appearance of a clear and colorless solution indicates that the absorption maxima has been reduced or eliminated.

The compositions disclosed herein can undergo a discoloration in combination with an evaporation process. By selecting a particular evaporation time for a composition, the discoloration time may also be controlled. In certain embodiments, when 1 ml of the composition is applied to a flat surface under standard conditions, the compositions will evaporate to constant weight in a period of less than 300 seconds, less than 240 seconds, less than 210 seconds, less than 180 seconds, less than 150 seconds, less than 120 seconds, less than 90 seconds, less than 75 seconds, less than 60 seconds, less than 45 seconds, less than 30 seconds, or less than 15 seconds. In some embodiments, when 1 ml of the composition is applied to a flat surface under standard conditions, at least 95% of the composition will evaporate in a period of less than 300 seconds, less than 240 seconds, less than 210 seconds, less than 180 seconds, less than 150 seconds, less than 120 seconds, less than 90 seconds, less than 75 seconds, less than 60 seconds, less than 45 seconds, less than 30 seconds, or less than 15 seconds.

### Cleaning Articles

The disclosed compositions may be deployed in a variety of forms, including by spraying or by transfer from a cleaning article (e.g., a substrate such as wipes, cloths, sponges, and the like).

As used herein, the term “substrate” is intended to include any material that can absorb and release the disclosed compositions. Examples of substrates include, but are not limited to wovens, nonwovens, sponges, films, and similar materials. In some instances, the substrate can be attached to a cleaning implement (e.g., a brush). In some instances, the substrate may be a wipe, for example a woven or non-woven fabric.

Exemplary substrate fabrics include wood pulp fibers, natural polymers, and synthetic polymers. Exemplary wood pulps include chemical pulps, such as Kraft, sulfite, and sulfate pulps, as well as mechanical pulps including, for example, groundwood, thermomechanical pulp and chemically modified thermomechanical pulp. The wood pulp can be from deciduous trees (hardwood pulps) and/or coniferous trees (softwood pulps). Exemplary natural polymers include starch, starch derivatives, cellulose and cellulose derivatives, hemicellulose, and hemicellulose derivatives. Exemplary synthetic polymers include polyethylene, polypropylene, poly(lactic acid), poly(vinylpyrroldinone), poly(caprolactone), polyesters, polystyrene, and poly(hydroxyalkanoate). In some embodiments, the synthetic polymer includes polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins such as polyethylene (e.g., PULPEX®) and polypropylene, polyamides such as nylon, polyesters such as DACRON® or KODELL®, polyurethanes, polystyrenes, and combinations thereof.

In some embodiments, the fabric may be exclusively one of wood pulp fibers, natural polymers, or synthetic polymers, while in other embodiments the fabric may include a mixture of two or more types of material. For example, the fabric may include synthetic polymers in an amount from 1-99 wt. %, from 10-90 wt. %, from 50-95 wt. %, from 5-50 wt. %, from 1-25 wt. %, from 25-50 wt. %, from 50-75 wt. %, from 75-99 wt. %, or from 40-60 wt. %, on a dry fabric basis, and the balance being wood pulp fibers and/or natural fibers. In other embodiments, the fabric may include wood pulps in an amount from 1-99 wt. %, from 10-90 wt. %, from 50-95 wt. %, from 5-50 wt. %, from 1-25 wt. %, from 25-50 wt. %, from 50-75 wt. %, from 75-99 wt. %, or from 40-60 wt. %, on a dry fabric basis, and the balance being synthetic and/or natural fibers.

In certain embodiments, the substrate can be a web, such as a wet laid tissue web or air laid web. Particularly preferred applicators include fibrous webs, including cellulosic webs and nonwoven webs of synthetic fibrous material. Useful webs may be wet laid, air laid, meltblown, or spunbonded. Suitable synthetic fibrous material includes meltblown polyethylene, polypropylene, copolymers of polyethylene and polypropylene, bicomponent fibers including polyethylene or polypropylene, and the like. Useful nonwoven webs may be meltblown, coform, spunbond, airlaid, hydroentangled nonwovens, spunlace, bonded carded webs.

The composition can be added to the substrate in varying amounts. For example, the composition may be loaded/absorbed onto the substrate an amount of at least 100 wt. %, at least 150 wt. %, at least 200 wt. %, at least 300 wt. %, at least 400 wt. %, at least 500 wt. %, at least 600 wt. %, at least 700 wt. %, at least 800 wt. %, at least 900 wt. %, or at least 1,000 wt. %, relative to the dry weight of the substrate. In certain embodiments, the composition may be loaded/absorbed onto the substrate an amount from 50-1,000 wt. %, 100-1,000 wt. %, from 200-1,000 wt. %, from 100-1,000 wt. %, from 200-1,000 wt. %, from 100-1,000 wt. %, from 200-1,000 wt. %, from 300-1,000 wt. %, from 400-1,000 wt. %, from 500-1,000 wt. %, from 600-1,000 wt. %, from 750-1,000 wt. %, from 100-500 wt. %, or from 250-750 wt. %, relative to the dry weight of the substrate.

The disclosed compositions can be used to determine whether a sanitizing and/or disinfecting composition has been applied to a given surface by applying the composition to the surface and visually determining (by the presence of colored liquid) whether the surface is covering the area of interest. Also disclosed are methods of determining whether a substrate is sufficiently loaded with a sanitizing and/or disinfecting composition to ensure transfer of an effective amount of the composition from the substrate to the surface. The visual appearance of the colored composition indicates that sufficient liquid is present to ensure effective transfer of active agent to a surface of interest. A discolored composition (i.e., clear) in the article indicates that insufficient liquid is present and insufficient transfer will occur.

The compositions may be used to eliminate a wide variety of pathogens, including microorganisms. In some implementations, the compositions may be used to eliminate pathogens including but not necessarily limited to, bacteria, fungi, viruses, and parasites.

The compositions may be used to eliminate gram-positive bacteria (for example Vibrio, Salmonella, Shigella, pseudomonas, Escherichia, Klebsiella, Proteus, Enterobacter, Serratia, Moraxella, Legionella, Bordetella, Gardnerella, Haemophilus, Neisseria, Brucella, Yersinia, Pasteurella, Bacteroids, and Helicobacter) and/or gram negative bacteria (for example, Vibrio, Salmonella, Shigella, pseudomonas, Escherichia, Klebsiella, Proteus, Enterobacter, Serratia, Moraxella, Legionella, Bordetella, Gardnerella, Haemophilus, Neisseria, Brucella, Yersinia, Pasteurella, Bacteroids, and Helicobacter). In some embodiments, the disclosed compositions will achieve at least a 5-log reduction in a bacterial species on a surface (i.e., a 99.999% reduction) within 150 seconds, within 120 seconds, within 90 seconds, within 60 seconds, within 45 seconds, within 30 seconds, or within 15 seconds. In certain embodiments, after 30 seconds, the disclosed compositions can achieve at least a 2-log reduction, at least a 3-log reduction, at least a 4-log reduction, at least a 5-log reduction, or at least a 6-log reduction.

In some embodiments, the compositions may be used to eliminate mold and fungi such as Candida (e. g., Candida albicans), Aspergillus species, dermatophytes such as Trichophyton ubrura, Trichophyton mentagrophytes, Microsporum canis, Microsporum gypseux, as well as Epiderophyton floccosum, Cladosporium, Fusarium, Alternaria, Curvularia, Aspergillus, and Penicillium. In some embodiments, the disclosed compositions will achieve at least a 5-log reduction in a fungal species (i.e., a 99.999% reduction) within 150 seconds, within 120 seconds, within 90 seconds, within 60 seconds, within 45 seconds, within 30 seconds, or within 15 seconds. In certain embodiments, after 30 seconds, the disclosed compositions can achieve at least a 2-log reduction, at least a 3-log reduction, at least a 4-log reduction, at least a 5-log reduction, or at least a 6-log reduction.

In some embodiments, the disclosed compositions may be used to eliminate viruses, including Baculoviridae, Herpesviridae, Iridoviridae, Poxviridae, “African Swine Fever Viruses,” Adenoviridae, Caulimoviridae, Myoviridae, Phycodnaviridae, Tectiviridae, Papovaviridae, Circoviridae, Parvoviridae, Hepadnaviridae, Cystoviridae, Bimaviridae, Reoviridae, Coronaviridae, Flaviviridae, Togaviridae, “Arterivirus,” Astroviridae, Caliciviridae, Picornaviridae, Potyviridae, Retroviridae, Orthomyxoviridae, Filoviridae, Paramyxoviridae, Rhabdoviridae, Arenaviridae, and Bunyaviridae. In a preferred embodiment, the compositions can be used to eliminate SARS-CoV-2. Other specific viruses which may be eliminated include herpes, pox, papilloma, corona, HIV, influenza, hepatitis, sendai, sindbis and vaccinia viruses, West Nile, and hanta virus. In some embodiments, the disclosed compositions will achieve at least a 3-log reduction in a viral species (i.e., a 99.9% reduction) within 150 seconds, within 120 seconds, within 90 seconds, within 60 seconds, within 45 seconds, within 30 seconds, or within 15 seconds. In certain embodiments, after 30 seconds, the disclosed compositions can achieve at least a 2-log reduction, at least a 3-log reduction, at least a 4-log reduction, at least a 5-log reduction, or at least a 6-log reduction.

The compositions disclosed herein may be applied to a variety of surfaces, including those found in kitchens and bathrooms, medical and dental offices, manufacturing facilities, and any other location where removal of pathogens is desired. The types of surfaces that may be sanitized and/or disinfected using the compositions is not limited, and includes surfaces composed of leather, wood, metal, plastic, synthetics, and fabrics.

The compositions may be applied to surfaces using any known method. For example, the composition can be applied by spraying, fogging, misting, exposure to aerosols, wiping, drenching, or immersing.

### Examples

The following examples are for the purpose of illustration of the disclosed embodiments only and are not intended to limit the scope of the present invention in any manner whatsoever.

The following experiments were conducted using 1,1′-dimethyl-4,4′-cyanine iodide as the cyanine dye and were repeated using 1,1′-dibutyl-4,4′-cyanine iodide as the cyanine dye. The results as described in Examples 1-11 were the same with 1,1′-dimethyl-4,4′-cyanine iodide and 1,1′-dibutyl-4,4′-cyanine iodide. Accordingly, the term “cyanine dye” in Examples 1-11 means “1,1′-dimethyl-4,4′-cyanine iodide or 1,1′-dibutyl-4,4′-cyanine iodide.”

Example 1: A solution was prepared to contain 0.06 mg/ml of cyanine dye, 0.625 mg/ml citric acid, and 5% benzalkonium chloride in ethanol. The solution's color was blue.

Example 2: When the blue solution in Example 1 was spread on a white ceramic substrate or cardboard, the blue color disappeared when all the ethanol evaporated.

Example 3: The blue solution in Example 1 was used to soak a substrate with 300% loading of the solution over the total weight of the substrate (e.g., spunlace or hydroknit materials). The soaked substrate showed blue. When the substrate was dried in a fume hood, the substrate became colorless.

Example 4: The pre-saturated substrate in Example 3 was used to wipe a white ceramic board or paper board. Some of the liquid was transferred to the surface to form a thin layer of blue solution. The blue color disappeared after about 60 seconds.

Example 5: A solution was prepared to contain 0.06 mg/ml of cyanine dye, 2.5 mg/ml citric acid, and 5% benzalkonium chloride in ethanol. The solution's color was blue.

Example 6: The blue solution in Example 5 was used to soak a substrate with 300% loading of the solution over the total weight of the substrate (e.g., spunlace or hydroknit materials). The soaked substrate showed blue. When the substrate was dried in a fume hood, the substrate became colorless.

Example 7: The pre-saturated substrate in Example 5 was used to wipe a white ceramic board or paper board. Some of the liquid was transferred to the surface to form a thin layer of blue solution. The blue color disappeared after about 30 seconds.

Example 8: A solution was prepared to contain 0.06 mg/ml of cyanine dye, 0.625 mg/ml citric acid, and 5% benzalkonium chloride in butanol. The solution's color was blue.

Example 9: The blue solution in Example 8 was used to soak a substrate with 300% loading of the solution over the total weight of the substrate (e.g., spunlace or hydroknit materials). The soaked substrate showed blue. When the substrate was dried in a fume hood, the substrate became colorless.

Example 10: The pre-state substrate in Example 9 was used to wipe a white ceramic board or paper board. Some of the liquid was transferred to the surface to form a thin layer of blue solution. The blue color disappeared after about 120 seconds.

Example 11: Examples 1 to 10 were repeated by replacing benzalkonium chloride with chlorhexidine digluconate, by replacing citric acid with tartaric acid, and by replacing ethanol or butanol with a mixing solvent of ethanol/water or isopropanol/water. The solution's blue color disappeared when dried either on substrates or applied on surfaces. Depending upon the amount and types of acids and the type of solvents, the discoloration timing varied.

### Embodiments

In view of the foregoing description and examples, the present disclosure provides the following embodiments.

Embodiment 1: A composition comprising an active agent, a cyanine dye, an acid, and a solvent, wherein the composition undergoes a discoloration upon exposure to standard conditions.

Embodiment 2: The composition according to embodiment 1, wherein the composition exhibits an absorption maxima in the region between 400-750 nm, between 400-700 nm, between 400-600 nm, between 400-500 nm, between 400-600 nm, between 450-550 nm, between 450-550 nm, between 500-600 nm, between 500-700 nm, between 550-650 nm, between 600-700 nm, or between 650-750 nm.

Embodiment 3: The composition according to embodiment 2, wherein the absorption maxima is reduced by at least 80%, at least 85%, at least 90%, at least 95%, at least 97.5%, or at least 99%, when 1 ml of composition is deposited on a flat surface and exposed to standard conditions for 180 seconds.

Embodiment 4: The composition according to any preceding embodiment, wherein the solvent comprises an organic solvent having a boiling point (at 1 atm) of less than 150° C., less than 140° C., less than 130° C., less than 120° C., less than 110° C., less than 100° C., less than 90° C., less than 80° C., less than 70° C., less than 60° C., or less than 50° C.

Embodiment 5: The composition according to any preceding embodiment, wherein the solvent comprises an alcohol, a ketone, an ester, water or a combination thereof.

Embodiment 6: The composition according to any preceding embodiment, wherein the solvent comprises a C₂₋₆alkylalcohol.

Embodiment 7: The composition according to any preceding embodiment, wherein the solvent comprises methanol ethanol, propanol, isopropanol, butanol, sec-butanol, tert-butyl alcohol, isobutanol, pentanol, isoamyl alcohol, 2-methyl-1-butanol, neopentyl alcohol, 2-pentanol, 3-methyl-2-butanol, 3-pentanol, tert-amyl alcohol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 3,3-dimethyl-1-butano, pentanols, hexanols, octanols, or a combination thereof.

Embodiment 8: The composition according to any preceding embodiment, wherein the solvent has a boiling point (at 1 atm) of less than 120° C.

Embodiment 9: The composition according to any preceding embodiment, wherein the solvent comprises ethanol, butanol, n-propanol, i-propanol, n-butanol, i-butanol, or a combination thereof.

Embodiment 10: The composition according to any preceding embodiment, wherein the solvent comprises water in an amount (v/v) from 5-95%, from 5-50%, from 5-25%, from 5-15%, from 5-10%, from 10-20%, from 15-30%, from 25-50%, from 40-60%, from 25-75%, from 50-75%, from 50-95%, from 75-95%, from 80-95%, or from 90-95%.

Embodiment 11: The composition according to any preceding embodiment, wherein the solvent comprises water in an amount (v/v) from 0-5%, from 0-2.5%, from 0-1.5%, from 0-1%, from 0-0.5%, from 0-0.25%, or from 0-0.1%.

Embodiment 12: The composition according to any preceding embodiment, wherein the active agent comprises an antibacterial agent, an antiviral agent, an antifungal agent, an antiparasitic agent, or combination thereof.

Embodiment 13: The composition according to any preceding embodiment, wherein the active agent is present in an amount from 0.01-25 wt. %, from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %.

Embodiment 14: The composition according to any preceding embodiment, wherein the composition comprises a quaternary ammonium compound.

Embodiment 15: The composition according to any preceding embodiment, wherein the composition comprises a quaternary ammonium compound having the formula:

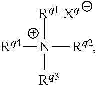

wherein R^{q1}, R^{q2}, R^{q3}, and R^{q4} are independently selected from C₁₋₂₀alkyl, C₀₋₄alkaryl, and C₀₋₄alkheteroaryl, wherein any two or more of R^{q1}, R^{q2}, R^{q3}, and R^{q4} can together with the nitrogen atom form ring, and X^{q} is an acceptable anion.

Embodiment 16: The composition according to embodiment 15, wherein R^{q2}, R^{q3}, and R^{q4} are each independently selected from C₁₋₄alkyl, and R^{q1} is C₆₋₂₀alkyl or C₀₋₄alkaryl.

Embodiment 17: The composition according to any of embodiments 15-16, wherein R^{q3} and R^{q4} are each methyl, R^{q2} is C₄₋₁₀alkyl, and R^{q1} is C₇₋₂₀alkyl or C₀₋₄alkaryl

Embodiment 18: The composition according to any of embodiments 14-17, wherein the quaternary ammonium compound comprises alkyl dimethyl benzyl ammonium chloride, alkyl dimethyl ethylbenzyl ammonium chloride, octyl decyl dimethyl ammonium chloride, dioctyl dimethyl ammonium chloride, didecyl dimethyl ammonium chloride, benzethonium chloride, ethylbenzyl alkonium chloride, ethyl benzethonium chloride, myristyl trimethyl ammonium chloride, methyl benzethonium chloride, cetalkonium chloride, cetrimonium bromide (CTAB), carnitine, dequalinium chloride, dofanium chloride, tetraethyl ammonium bromide (TEAB), domiphen bromide, octenidine dihydrochloride, cetrimide, benzododecinium bromide, benzoxonium chloride, choline, and denatonium.

Embodiment 19: The composition according to any preceding embodiment, wherein the composition comprises a quaternary ammonium compound in an amount 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %.

Embodiment 20: The composition according to any preceding embodiment, wherein the composition comprises a biguanide compound.

Embodiment 21: The composition according to embodiment 20, wherein the biguanide comprises ethylenedibiguanide, propylenedibiguanide, tetramethylenedibiguanide, pentamethylenedibiguanide, hexamethylenedibiguanide, heptamethylenedibiguanide, octamethylenedibiguanide, 1,6-bis-(4-chlorobenzylbiguanido)-hexane (Fluorhexidine®), 1,1′-hexamethylene bis(5-(p-chlorophenyl)biguanide) (chlorhexidine), 2-(benzyloxymethyl)pentane-1,5-bis(5-hexylbiguanide), 2-(phenylthiomethyl)pentane-1,5-bis(5-phenethylbiguanide), 3-(phenylthio)hexane-1,6-bis(5-hexylbiguanide), 3-(phenylthio)hexane-1,6-bis(5-cyclohexylbiguanide), 3-(benzylthio)hexane-1,6-bis(5-hexylbiguanide), and 3-(benzylthio)hexane-1,6-bis(5-cyclohexylbiguanide), phenylenyldibiguanide, naphthylenyldibiguanide, pyridinyldibiguanide, piperazinyldibiguanide, phthalyldibiguanide, 1,1′-[4-(dodecyloxy)-m-phenylene]bisbiguanide, 2-(decylthiomethyl)pentane-1,5-bis(5-isopropylbiguanide), 2-(decylthiomethyl)pentane-1,5-bis(5,5-diethylbiguanide), alexidine, salts thereof, or a combination thereof.

Embodiment 22: The composition according to any preceding embodiment, wherein the composition comprises a biguanide compound in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %.

Embodiment 23: The composition according to any preceding embodiment, wherein the composition comprises a surfactant.

Embodiment 24: The composition according to any preceding embodiment, wherein the composition comprises a surfactant in an amount from 0.01-5 wt. %, from 0.1-5 wt. %, from 0.1-2.5 wt. %, from 0.5-5 wt. %, from 1-2.5 wt. %, from 1-5 wt. %, from 2.5-7.5 wt. %, from 2.5-10 wt. %, from 5-15 wt. %, from 5-10 wt. %, from 10-15 wt. %, from 10-20 wt. %, from 10-25 wt. %, or from 15-25 wt. %.

Embodiment 25: The composition according to any preceding embodiment, wherein the composition comprises an anionic surfactant, cationic surfactant, non-ionic surfactant, or a combination thereof.

Embodiment 26: The composition according to any preceding embodiment, wherein the composition comprises a sulfonate surfactant, carboxylate surfactant, sulfate surfactant, or a combination thereof.

Embodiment 27: The composition according to any preceding embodiment, wherein the composition comprises sodium dodecyl sulfate, sodium dodecylbenzenesulfonate, sodium laurate, sodium laureth sulfate, sodium lauryl sarcosinate, potassium lauryl sulfate, ammonium lauryl sulfate, ammonium laureth sulfate, ammonium xylene sulfonate, magnesium laureth sulfate, sodium myreth sulfate, sodium nonanoyloxybenzenesulfonate, ammonium xylene sulfonate, or a combination thereof.

Embodiment 28: The composition according to any preceding embodiment, wherein the composition comprises an anionic surfactant.

Embodiment 29: The composition according to any preceding embodiment, wherein the composition comprises a non-ionic surfactant.

Embodiment 30: The composition according to any preceding embodiment, wherein the composition comprises betaines such as cocamidopropyl betaine, sultaines such as cocamidopropyl hydroxyl sultaine and lauramidopropyl hydroxyl sultaine, amphoacetates and amphodiacetates, such as disodium lauroamphodiacetate, disodium cocoamphodiacetate, sodium lauroamphoacetate, sodium cocoamphoacetate, disodium cocoamphodipropionate, disodium lauroamphodipropionate, or a combination thereof.

Embodiment 31: The composition according to any preceding embodiment, wherein the composition comprises at least one anionic surfactant and at least one non-ionic surfactant.

Embodiment 32: The composition according to any preceding embodiment, wherein the composition comprises an acid in a concentration from 0.05-50 mg/ml, from 10-50 mg/ml, from 25-50 mg/ml, from 10-25 mg/ml, from 0.05-25 mg/ml, from 0.05-10 mg/ml, from 0.1-10 mg/ml, from 0.5-10 mg/ml, from 1-10 mg/ml, from 2-10 mg/ml, from 4-10 mg/ml, from 5-10 mg/ml, from 7.5-10 mg/ml, from 0.05-2.5 mg/ml, from 0.1-2.5 mg/ml, from 0.5-2.5 mg/ml, from 1-2.5 mg/ml, from 1-5 mg/ml, or from 2.5-5 mg/ml.

Embodiment 33: The composition according to any preceding embodiment, wherein the acid comprises a polyacid.

Embodiment 34: The composition according to any preceding embodiment, wherein the acid comprises a polyacid having two or three acidic groups.

Embodiment 35: The composition according to any preceding embodiment, wherein the composition comprises an acid having a boiling point (at 1 atm) of at least 100° C., at least 125° C., at least 150° C., at least 200° C., at least 250° C., at least 300° C., at least 350° C., or at least 400° C.

Embodiment 36: The composition according to any preceding embodiment, wherein the composition comprises an acid having a melting point of at least 75° C., at least 100° C., at least 125° C., at least 150° C., at least 175° C., at least 200° C., at least 250° C., or at least 300° C.

Embodiment 37: The composition according to any preceding embodiment, wherein the composition comprises an acid having a pKa from 0-6.5, from 1-6.5, from 2-6.5, from 3-6.5, from 4-6.5, from 5-6.5, from 1-3, from 2-4, or from 3-5 (measured in water at 23° C.).

Embodiment 38: The composition according to any preceding embodiment, wherein the composition comprises a compound having a single acidic group, two acidic groups, three acidic groups, or more than three acidic groups.

Embodiment 39: The composition according to any preceding embodiment, wherein the composition comprises acetic acid, adipic acid, benzene dicarboxylic acid, benzoic acid, butyric acid, citric acid, cresylic acid, capric acid, caproic acid, cyanuric acid, dihydroacetic acid, 2-ethyl-hexanoic acid, formic acid, fumaric acid, gluconic acid, glycolic acid, 1-glutamic acid, lactic acid, maleic acid, malic acid, mesyl acid, naphthenic acid, oxalic acid, phytic acid, polyacrylic acid, propanoic acid, salicylic acid, sorbic acid, tartaric acid, valeric acid, or a combination thereof.

Embodiment 40: The composition according to any preceding embodiment, wherein the composition comprises citric acid, tartaric acid, fumaric acid, malic acid, maleic acid, or a combination thereof.

Embodiment 41: The composition according to any preceding embodiment, wherein the cyanine dye comprises a streptocyanine, hemicyanine, closed chain cyanine, merocyanine, apocyanine, or combination thereof.

Embodiment 42: The composition according to any preceding embodiment, wherein the cyanine dye comprises a quinocyanine, isoquinocyanine, mixed quino/isoquinocyanine, indolenium cyanine, or combination thereof.

Embodiment 43: The composition according to any preceding embodiment, wherein composition comprises the acid and cyanine dye in a weight ratio from 1:1 to 500:1, from 1:1 to 250:1, from 1:1 to 100:1, from 1:1 to 75:1, from 1:1 to 50:1, from 1:1 to 40:1 from 1:1 to 30:1, from 1:1 to 20:1, from 1:1 to 10:1, from 5:1 to 50:1, from 10:1 to 25:1, from 10:1 to 50:1, from 20:1 to 50:1, from 25:1 to 50:1, from 25:1 to 75:1, from 50:1 to 100:1, from 50:1 to 150:1, or from 100:1 to 500:1.

Embodiment 44: An article, comprising: a substrate, and the composition according to any preceding embodiment absorbed upon the substrate.

Embodiment 45: The article according to embodiment 44, wherein the substrate comprises the composition in an amount of at least 100 wt. %, at least 150 wt. %, at least 200 wt. %, at least 300 wt. %, at least 400 wt. %, at least 500 wt. %, at least 600 wt. %, at least 700 wt. %, at least 800 wt. %, at least 900 wt. %, or at least 1,000 wt. %, relative to the dry weight of the substrate.

Embodiment 46: The article according any of embodiments 44-45, wherein the substrate comprises the composition in an amount from 50-1,000 wt. %, 100-1,000 wt. %, from 200-1,000 wt. %, from 100-1,000 wt. %, from 200-1,000 wt. %, from 100-1,000 wt. %, from 200-1,000 wt. %, from 300-1,000 wt. %, from 400-1,000 wt. %, from 500-1,000 wt. %, from 600-1,000 wt. %, from 750-1,000 wt. %, from 100-500 wt. %, or from 250-750 wt. %, relative to the dry weight of the substrate.

Embodiment 47: The article according to any of embodiments 44-46, wherein the article is a wipe, cloth, or sponge.

Embodiment 48: A method of disinfecting a surface, comprising: applying to the surface the composition according to any preceding embodiment, wherein the composition disinfects the surface by eliminating a pathogen on the surface.

Embodiment 49: The method according to embodiment 48, wherein the disinfecting comprises at least a 3-log reduction in the pathogen.

Embodiment 50: The method according to embodiment 49, wherein the pathogen comprises a bacteria, fungi, virus, parasite, or combination thereof.

Embodiment 51: The method according to any of embodiments 49-50, wherein the pathogen comprises a gram-negative, gram-positive bacteria, or combination thereof.

Embodiment 52: The method according to any of embodiments 49-51, wherein the disinfecting provides a 5 log or greater reduction in the pathogen.

Embodiment 53: The method according to any of embodiments 48-52, comprising removing residual composition from the surface following discoloration of the composition.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A composition comprising an active agent, a cyanine dye, an acid, and a solvent, wherein the composition undergoes a discoloration upon exposure to standard conditions.

2. The composition according to claim 1, wherein the composition exhibits an absorption maxima in the region between 400-750 nm.

3. The composition according to claim 2, wherein, during the discoloration, the composition's absorption maxima is reduced by at least 80% when 1 ml of composition is deposited on a flat surface and exposed to standard conditions for at least 180 seconds.

4. The composition according to claim 1, wherein the solvent comprises an organic solvent having a boiling point (at 1 atm) of less than 120° C.

5. The composition according to claim 1, wherein the solvent comprises an alcohol, a ketone, an ester, water, or a combination thereof.

6. The composition according to claim 1, wherein the solvent comprises a C₂₋₆alkylalcohol.

7. The composition according to claim 1, wherein the active agent comprises an antibacterial agent, an antiviral agent, an antifungal agent, an antiparasitic agent, or a combination thereof.

8. The composition according to claim 1, wherein the active agent comprises a quaternary ammonium compound, a biguanide compound, or a combination thereof.

9. The composition according to claim 8, wherein the composition comprises the quaternary ammonium compound, the biguanide compound, or a combination thereof, in an amount 0.01-25 wt. %.

10. The composition according to claim 1, wherein the active agent comprises an anionic surfactant, cationic surfactant, non-ionic surfactant, or a combination thereof.

11. The composition according to claim 10, wherein the composition comprises a surfactant in an amount from 0.01-25 wt. %.

12. The composition according to claim 1, wherein the acid comprises a polyacid having two or three acidic groups.

13. The composition according to claim 12, wherein the composition comprises citric acid, tartaric acid, fumaric acid, malic acid, maleic acid, or a combination thereof.

14. The composition according to claim 1, wherein the acid has a boiling point (at 1 atm) of at least 200° C.

15. The composition according to claim 1, wherein the cyanine dye comprises a streptocyanine, hemicyanine, closed chain cyanine, merocyanine, apocyanine, or a combination thereof.

16. The composition according to claim 15, wherein the cyanine dye comprises a closed chain cyanine.

17. The composition according to claim 1, wherein composition comprises the acid and cyanine dye in a weight ratio from 1:1 to 500:1.

18. The composition of claim 1, wherein the cyanine dye is 1,1′-dimethyl-4,4′-cyanine iodide or 1,1′-dibutyl-4,4′-cyanine iodide.

19. The composition of claim 1, wherein the cyanine dye is 1,1′-dimethyl-4,4′-cyanine iodide or 1,1′-dibutyl-4,4′-cyanine iodide; wherein the acid is citric acid; wherein the active agent is benzalkonium chloride; and wherein the solvent is ethanol.

20. The composition of claim 1, wherein the cyanine dye is 1,1′-dimethyl-4,4′-cyanine iodide or 1,1′-dibutyl-4,4′-cyanine iodide; wherein the acid is tartaric acid; wherein the active agent is chlorhexidine gluconate; and wherein the solvent is butanol.

21. An article, comprising: a substrate, and the composition according to claim 1 loaded upon the substrate.

22. The article according to claim 21, wherein the substrate comprises the composition in an amount of at least 100 wt. % relative to the dry weight of the substrate.

23. A method of disinfecting a surface, comprising: applying to the surface the composition according to claim 1, wherein the composition disinfects the surface by eliminating a pathogen on the surface.
